(19) United States
(12) Patent Application Publication
(10) Pub. No.: US 2024/0220516 A1
(43) Pub. Date: Jul. 4, 2024

(54) INFORMATION PROCESSING APPARATUS, ANALYSIS METHOD AND PROGRAM

(71) Applicant: NIPPON TELEGRAPH AND TELEPHONE CORPORATION, Tokyo (JP)

(72) Inventors: Atsushi SAKURAI, Tokyo (JP); Minako HARA, Tokyo (JP)

(73) Assignee: NIPPON TELEGRAPH AND TELEPHONE CORPORATION, Tokyo (JP)

(21) Appl. No.: 18/558,362

(22) PCT Filed: May 11, 2021
(86) PCT No.: PCT/JP2021/017942

§ 371 Date: Oct. 31, 2023

(51) Int. Cl. G06F 16/31; G06F 16/33

(52) U.S. Cl. CPC G06F 16/313; G06F 16/3344

(57) ABSTRACT

An information processing device includes a posting history acquisition unit which acquires posting history data indicating a history of posts to an SNS; an analysis unit which analyzes elements common to words and phrases included in the posting history data; and a data generation unit which generates data indicating elements common to the words and phrases and information indicating the reliability of each of the elements on the basis of the analyzed result.

### TECHNICAL FIELD

The present invention relates to an information processing device, an analysis method, and a program.

### BACKGROUND ART

With the spread of SNSs, a technique for analyzing relationships between SNS users and related parties via the SNS is known.

For example, PTL 1 describes a technique for improving the analysis accuracy of relationships by using reply information in addition to posted information.

### CITATION LIST

### Patent Literature

[PTL 1] Japanese Patent Application Publication No. 2020-173593

### SUMMARY OF INVENTION

### Technical Problem

The technique in the related art has a problem that it is not possible to perform an analysis that takes account of the reliability of the posted information.

An object of the disclosed technique is to analyze posted information in consideration of reliability.

### Solution to Problem

The disclosed technique is an information processing device which includes: a posting history acquisition unit which acquires posting history data indicating a history of posts to an SNS; an analysis unit which analyzes elements common to words and phrases included in the posting history data; and a data generation unit which generates data indicating elements common to the words and phrases and information indicating the reliability of each of the elements on the basis of the analysis result.

### Advantageous Effects of Invention

It is possible to perform an analysis that takes into account the reliability of posted information.

### BRIEF DESCRIPTION OF DRAWINGS

FIG. 1 is a functional constitution diagram of an information processing device.

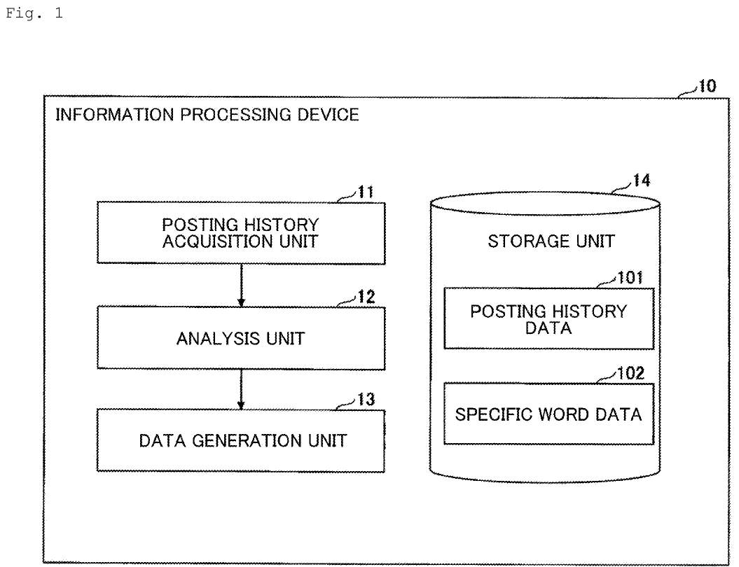

FIG. 2 is a diagram illustrating an example of posting history data.

FIG. 3 is a diagram illustrating an example of specific word data.

FIG. 4 is a flowchart for describing an example of a flow of specific word data generation processing.

FIG. 5 is a diagram illustrating a hardware configuration example of a computer.

### DESCRIPTION OF EMBODIMENTS

An embodiment (present embodiment) of the present invention will be described below with reference to the drawings. The embodiments which will be described below are merely examples and embodiments to which the present invention is applied are not limited to the following embodiments.

An information processing device 10 according to the present embodiment is a device which analyzes the content posted on a social networking service (SNS). The information processing device 10 includes a posting history acquisition unit 11, an analysis unit 12, a data generation unit 13, and a storage unit 14.

The posting history acquisition unit 11 acquires posting history data 101. The posting history data 101 is data indicating a history of posting to the SNS.

The analysis unit 12 analyzes elements common to words and phrases included in the posting history data. Specifically, the analysis unit 12 analyzes the relationship between each word/phrase included in the posting history data and the posted content before and after the word/phrase including the word/phrase.

The data generation unit 13 generates data (specific word data 102) indicating elements common to words and phrases and information indicating the reliability of each element on the basis of the analyzed result.

The storage unit 14 stores the posting history data 101 and the specific word data 102.

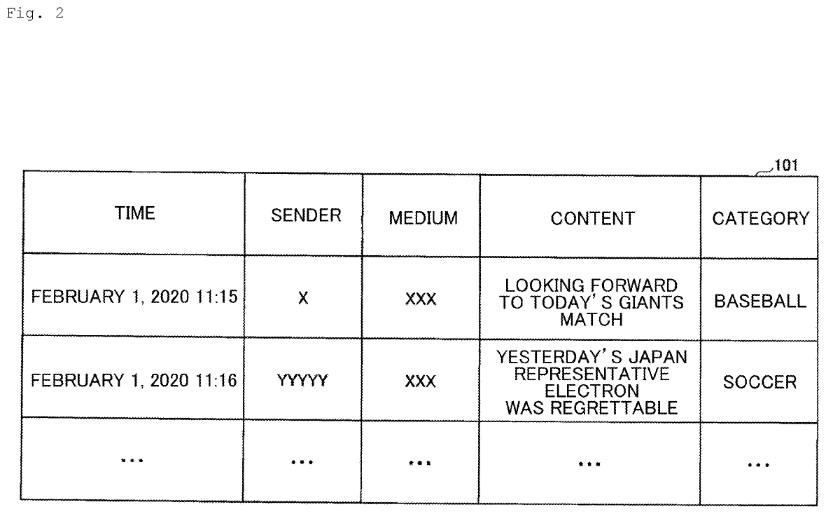

FIG. 2 is a diagram illustrating an example of posting history data.

The posting history data 101 includes items such as time, sender, medium, content, and category.

A value of the item “time” is the time when the post was made on the SNS. A value of the item “sender” is an identifier for identifying a sender, and is, for example, an account name or the like. A value of the item “medium” is an identifier for identifying a medium for receiving posting.

A value of the item “content” is posted text. A value of the item “category” is text indicating a category selected at the time of posting.

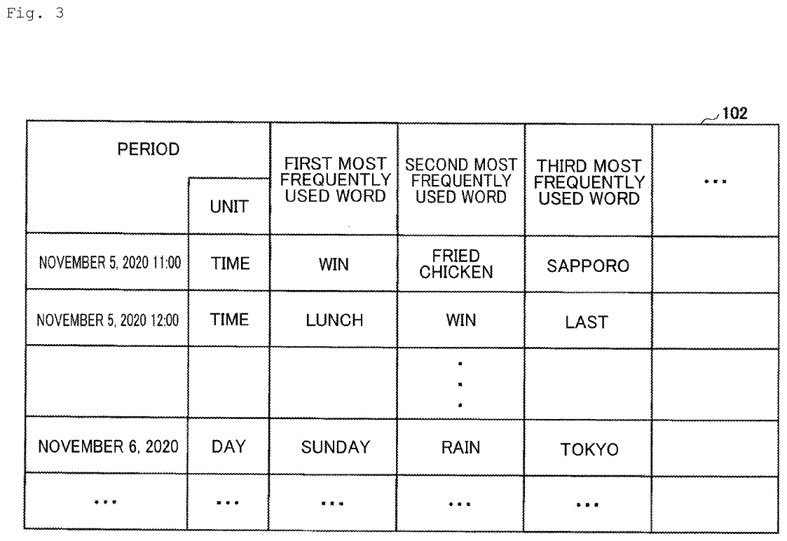

FIG. 3 is a diagram illustrating an example of specific word data 102.

The specific word data 102 includes, as items, a period and an order of frequency.

A value of the item “period” indicates the period for which the frequency of posting of words and phrases is aggregated in units of hours, days, weeks, months, years, or the like.

A value of the item “order of frequency” indicates words and phrases which are frequently posted during the target period for each order such as a first order, a second order, and a third order.

The words and phrases to be aggregated may be words, phrases, or sentences. Moreover, the analysis unit 12 may regard words and phrases which include common elements even if they are not the same as being the same. For example, when counting for each word/phrase, the analysis unit 12 may count “Company A” and “Company A” as the same word/phrase. In addition, when counting for each phrase, the analysis unit 12 may count “A do your best” and “A win” as the same word/phrase, and count “A do your best” and “A lose” as different word/phrases.

The order of frequencies described above is an example of information indicating the reliability of information. Other information indicating the reliability may be used, for example, the reliability regarding age may be one of “high”, “medium” and “low”. In this case, the analysis unit 12 may perform analysis so that, when the posted information matches, the reliability increases, and if they do not match, the reliability decreases when information that can be interpreted in the same way is posted multiple times in different ways.

For example, the analysis unit 12 may set the reliability to age as “low” from the content of the post “celebrity A and classmate” alone, but may set the reliability for age to “medium”, which is a higher reliability, if it is possible to determine that “celebrity A” and “celebrity B” are classmates by also analyzing the content of the post “classmate with celebrity B”.

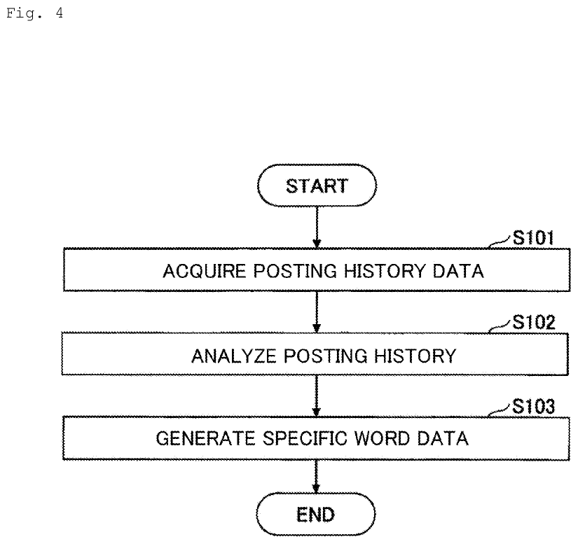

FIG. 4 is a flowchart for describing an example of the flow of specific word data generation processing.

The posting history acquisition unit 11 of the information processing device 10 acquires posting history data upon receiving a user's operation or the like (Step S101). For example, the posting history acquisition unit 11 may access a server which provides an SNS service, periodically aggregate posting histories, and store the aggregated results as the posting history data 101 in the storage unit 14.

Subsequently, the analysis unit 12 analyzes the acquired posting history data (Step S102). Specifically, the analysis unit 12 decomposes the posted text into words, phrases, or sentences by natural language processing. The analysis unit 12 may determine the identity of words or sentences using word vectors or the like.

The data generation unit 13 generates specific word data 102 on the basis of the analysis result (Step S103).

### Hardware Configuration Example According to Present Embodiment

The information processing device 10 can be realized, for example, by causing a computer to execute a program having the processing details described in the present embodiment written therein. Note that the “computer” may be a physical machine or a virtual machine on the cloud. When using a virtual machine, the “hardware” described herein is virtual hardware.

The above program can be saved by being recorded in a computer-readable recording medium (portable memory or the like) or distributed. It is also possible to provide the above program through a network such as the Internet or e-mail.

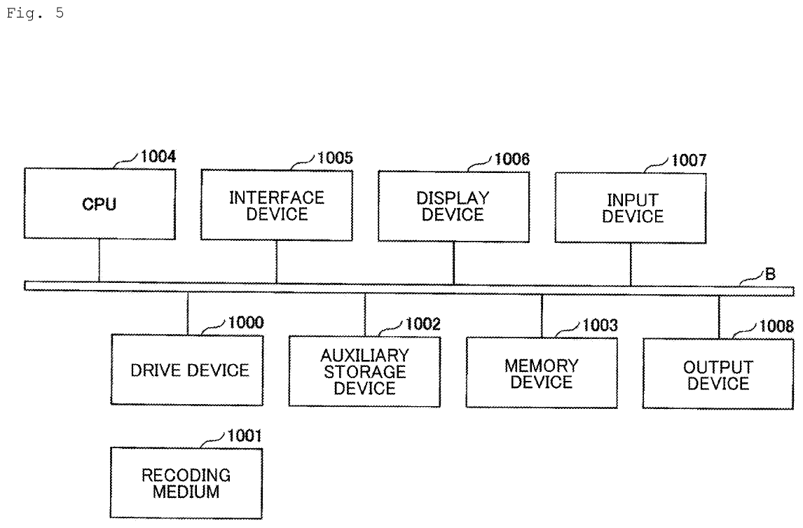

FIG. 5 is a diagram illustrating a hardware configuration example of the computer. The computer of FIG. 5 has a drive device 1000, an auxiliary storage device 1002, a memory device 1003, a CPU 1004, an interface device 1005, a display device 1006, an input device 1007, an output device 1008, and the like which are connected to each other via a bus B.

A program for realizing processing by the computer is provided by, for example, a recording medium 1001 such as a CD-ROM or a memory card. When a recording medium 1001 storing a program is set in the drive device 1000, the program is installed from the recording medium 1001 to the auxiliary storage device 1002 via the drive device 1000. Here, the program need not necessarily be installed from the recording medium 1001 and may be downloaded from another computer via the network. The auxiliary storage device 1002 stores installed programs as well as necessary files and data.

The memory device 1003 reads the program from the auxiliary storage device 1002 and stores it when a program activation instruction is received. The CPU 1004 implements functions relating to the device according to programs stored in the memory device 1003. The interface device 1005 is used as an interface for connecting to a network. The display device 1006 displays a graphical user interface (GUI) or the like by a program. The input device 1007 is composed of a keyboard, a mouse, buttons, a touch panel, or the like and is used for inputting various operational instructions. The output device 1008 outputs the calculation result.

According to the information processing device 10 according to the present embodiment, data indicating elements common to words and phrases and information indicating the reliability of each element is generated. Thus, it is possible to perform an analysis in which the reliability of the information is considered. Furthermore, since it does not analyze the presence or absence of direct communication between senders, for example, it is possible to analyze common trends for SNS users who do not have direct communication by matching.

### Summary of Embodiment

This specification describes at least the information processing device, the conversion method, and the program described in each of the following items.

### (Item 1)

An information processing device, comprising:
a posting history acquisition unit which acquires posting history data indicating a history of posts to an SNS; an analysis unit which analyzes elements common to words and phrases included in the posting history data; and
a data generation unit which generates data indicating elements common to the words and phrases and information indicating the reliability of each of the elements on the basis of the analyzed result.

### (Item 2)

The information processing device according to Item 1, wherein the analysis unit analyzes, for each of the words/phrases included in the posting history data, a relationship between pieces of content posted before and after the word/phrase including the word/phrase.

### (Item 3)

The information processing device according to Item 1 or 2, further comprising:
a storage unit which stores data indicating the posting history data, elements common to the words and phrases, and information indicating the reliability of each element.

### (Item 4)

The information processing device according to any one of Items 1 to 3, wherein the reliability of each element common to the word and phrase for each word and phrase is indicated by an order of the frequency with which the word and phrase is posted within the specified period.

### (Item 5)

An analysis method performed by a computer, comprising:
a step of acquiring posting history data indicating a history of posting to an SNS;
a step of analyzing elements common to words and phrases included in the posting history data; and
a step of generating data indicating the elements common to the words and phrases and information indicating reliability of each of the elements on the basis of the analyzed result.

### (Item 6)

A program causing a computer to function as each of the units in the information processing device according to any one of Items 1 to 4.

Although the present embodiment has been described above, the present invention is not limited to such a specific embodiment, and various modifications and changes are possible within the scope of the gist of the invention described in the claims.

### REFERENCE SIGNS LIST

10 Information processing device
11 Posting history acquisition unit
12 Analysis unit
13 Data generation unit
14 Storage unit
101 Posting history data
102 Specific word data
1000 Drive device
1001 Recording medium
1002 Auxiliary storage device
1003 Memory device
1004 CPU
1005 Interface device
1006 Display device
1007 Input device
1008 Output device

1. An information processing device comprising a processor configured to execute operations comprising:
acquiring posting history data, wherein the posting history data indicates a history of posts to a social network service;
analyzing elements common to words and phrases included in the posting history data; and
generating data indicating elements common to the words and phrases and information indicating the reliability of each of the elements on the basis of a result of the analyzing.

2. The information processing device according to claim 1, wherein the analyzing further comprises analyzing, for each of the words/phrases included in the posting history data, a relationship between pieces of content posted before and after a word/phrase including the word/phrase.

3. The information processing device according to claim 1, further comprising:
storing data indicating the posting history data, elements common to the words and phrases, and information indicating the reliability of each element.

4. The information processing device according to claim 1, wherein the reliability of each element common to the word and phrase for each word and phrase is indicated by an order of frequency with which the word and phrase is posted within the specified period.

5. An analysis method, comprising:
a step of acquiring posting history data, the posting history data indicating a history of posting to a social network service;
a step of analyzing elements common to words and phrases included in the posting history data; and
a step of generating data indicating the elements common to the words and phrases and information indicating reliability of each of the elements on the basis of a result of the analyzing.

6. A computer-readable non-transitory recording medium storing computer-executable program instructions that when executed by a processor cause a computer to execute operations comprising:
acquiring posting history data, wherein the posting history data indicates a history of posts to a social network service;
analyzing elements common to words and phrases included in the posting history data; and
generating data indicating elements common to the words and phrases and information indicating the reliability of each of the elements on the basis of a result of the analyzing.

7. The information processing device according to claim 2, further comprising:
storing data indicating the posting history data, elements common to the words and phrases, and information indicating the reliability of each element.

8. The information processing device according to claim 2, wherein the reliability of each element common to the word and phrase for each word and phrase is indicated by an order of frequency with which the word and phrase is posted within the specified period.

9. The information processing device according to claim 3, wherein the reliability of each element common to the word and phrase for each word and phrase is indicated by an order of frequency with which the word and phrase is posted within the specified period.

10. The analysis method according to claim 5, wherein the step of analyzing further comprises analyzing, for each of the words/phrases included in the posting history data, a relationship between pieces of content posted before and after a word/phrase including the word/phrase.

11. The analysis method according to claim 5, further comprising:
storing data indicating the posting history data, elements common to the words and phrases, and information indicating the reliability of each element.

12. The analysis method according to claim 5, wherein the reliability of each element common to the word and phrase for each word and phrase is indicated by an order of frequency with which the word and phrase is posted within the specified period.

13. The analysis method according to claim 10, further comprising:
storing data indicating the posting history data, elements common to the words and phrases, and information indicating the reliability of each element.

14. The analysis method according to claim 10, wherein the reliability of each element common to the word and phrase for each word and phrase is indicated by an order of frequency with which the word and phrase is posted within the specified period.

15. The analysis method according to claim 13, wherein the reliability of each element common to the word and phrase for each word and phrase is indicated by an order of frequency with which the word and phrase is posted within the specified period.

16. The computer-readable non-transitory recording medium according to claim 6, wherein the analyzing further comprises analyzing, for each of the words/phrases included in the posting history data, a relationship between pieces of content posted before and after a word/phrase including the word/phrase.

17. The computer-readable non-transitory recording medium according to claim 6, the computer-executable program instructions when executed further causing the computer execute operations comprising:
storing data indicating the posting history data, elements common to the words and phrases, and information indicating the reliability of each element.

18. The computer-readable non-transitory recording medium according to claim 6, wherein the reliability of each element common to the word and phrase for each word and phrase is indicated by an order of frequency with which the word and phrase is posted within the specified period.

19. The computer-readable non-transitory recording medium according to claim 16, the computer-executable program instructions when executed further causing the computer execute operations comprising:
storing data indicating the posting history data, elements common to the words and phrases, and information indicating the reliability of each element.

20. The computer-readable non-transitory recording medium according to claim 16, wherein the reliability of each element common to the word and phrase for each word and phrase is indicated by an order of frequency with which the word and phrase is posted within the specified period.
